(19) United States
(12) Patent Application Publication
(10) Pub. No.: US 2004/0169788 A1
(43) Pub. Date: Sep. 2, 2004

(54) Liquid crystal display module

(76) Inventor: Jae Woo Park, Kumi-shi (KR)

Correspondence Address: Rebecca Goldman Rudich, MCKENNA LONG & ALDRIDGE LLP, 1900 K Street, N.W., Washington, DC, 20006, US

(21) Appl. No.: 10/745,706

(22) Filed: Dec. 29, 2003

(30) Foreign Application Priority Data
Feb. 28, 2003 (KR) 2003-12635

(51) Int. Cl. G02F 1/1335

(52) U.S. Cl. 349/65

(57) ABSTRACT

A liquid crystal display module for preventing a noise is provided. In the module, a light guide plate is inserted into an inner side of a support main to uniformly distribute a light applied from a light source and apply the light to a liquid crystal display panel. The light guide plate is set such that a first side thereof to which a light is incident has a width different from a second side thereof which is opposed to the first side.

This application claims the benefit of Korean Patent Application No. P2003-12635, filed on Feb. 28, 2003, which is hereby incorporated by reference for all purposes as if fully set forth herein.

### BACKGROUND OF THE INVENTION

1. Field of the Invention

This invention relates to a liquid crystal display module, and more particularly to a liquid crystal display module which prevents noise.

2. Description of the Related Art

Generally, a liquid crystal display (LCD) displays a picture using a light applied from an exterior of the liquid crystal display. Thus, conventional LCDs include a liquid crystal display module.

Referring to FIG. 1 and FIG. 2, a conventional liquid crystal display module includes a support main 2, a backlight unit and a liquid crystal display panel 10 disposed at the inside of the support main 2, a cover bottom 14 enclosing one bottom and a side of the support main 2, and a case top 16 for enclosing an edge of the liquid crystal display panel 10 and the cover bottom 14.

The support main 2 is molded, and an inner sidewall is molded into a step coverage. An inner lowermost layer of the support main 2 is provided with the backlight unit at which the liquid crystal display panel 10 is provided.

The liquid crystal display panel 10 comprises a lower substrate 10b mounted with a switching device (i.e., a TFT) and an upper substrate 10a provided with color filters. The upper and lower sides of the liquid crystal display panel 10 are provided with polarizers 22 and 24. The lower polarizer 22, provided at a lower side of the liquid crystal display panel 10, polarizes a light beam applied from the backlight unit and applies the light beam to the liquid crystal display panel 10. The upper polarizer 24, provided at the upper side of the liquid crystal display panel 10, polarizes a light beam applied from the liquid crystal display panel 10 and emits the light beam into the exterior.

The cover bottom 14 encloses one bottom and side of the support main 2. The case top 16 encloses an upper and a side surface of the support main 2 thereby securing the support main 2 and the liquid crystal display panel 10.

The backlight unit includes a lamp housing 18 mounted with a light source 20, a light guide plate 6 for converting a light input from the light source 20 into plane light, optical sheets 12 attached to the light guide plate 6 to enhance an efficiency of a light incident to the liquid crystal display panel 10, and a reflector 4 attached to a rear side of the light guide plate 6 to reflect a light emitted into the rear side of the light guide plate 6 toward the liquid crystal display panel 10.

The light source 20 applies a desired light to the light guide plate 6 according to a power supplied with an external power supply. Simultaneously, light output from the light source 20 into the opposite side of the light guide plate 6 is reflected by the lamp housing 18 such that the light is incident to the light guide plate 6.

The light guide plate 6 uniformly distributes light input from the light source 20 to an entire area thereof. In other words, the light guide plate 6 uniformly distributes light input from the light source 20, thereby allowing incidence to the liquid crystal display of uniform light.

The reflector 4 reflects a light incident to the lower side of the light guide plate 6. Therefore, the reflector 4 reflects a light input from the light guide plate 6, thereby allowing application of a light incident thereto to the liquid crystal display panel 10.

The optical sheets 12 are comprised of upper/lower diffusing sheets and upper/lower prism sheets. The optical sheets 12 scatter light input from the light guide plate thereby evenly distributing the light at an entire surface of the light guide plate 6. Further, the optical sheets 12 make a refractive convergence of the scattered light thereby raising a surface brightness and diffusing the light to widen a viewing angle.

In such conventional liquid crystal display modules, the light guide plate 6 is formed in a rectangular shape as shown in FIG. 2A. The support main 2 has an inner side formed in a rectangular shape such that the light guide plate 6 can be inserted thereto as shown in FIG. 2B. The light guide plate 6 has a first width TI while the inner side of the support main 2 has a second width T2. As shown in FIG. 3, the second width T2 is larger than the first width T1 such that the light guide plate 6 can be inserted into the inner side of the support main 2.

The light guide plate 6 provided at the support main 2 uniformly distributes a light applied from the light source 20 toward a light input part 30 (i.e., a part provided with the light source 20) onto an entire area thereof, and applies the uniformly distributed light to the liquid crystal display panel 10. A distance between the light guide plate 6 and the support main 2 have the same width, that is, a third width T3 irrespective of their positions.

Current LCD technology trends toward a thin thickness and light weight. More particularly, an LCD mounted in a notebook computer requires a thin thickness and light weight for easy portability.

However, if the LCD has a thin thickness and light weight, then the liquid crystal display module has low mechanical strength. Thus, the liquid crystal display module may twist due to an external impact, etc. In other words, if twist occurs at the support main 2, then mechanical friction between the support main 2 and the light guide plate 6 caused by the twisting creates noise. In this case, there is little mechanical friction at the light input part 30 of the liquid crystal display module. However, mechanical friction occurs at the opposite side of the light input part 30. Therefore, the side of the light input part 30 has a high mechanical strength.

### SUMMARY OF THE INVENTION

Accordingly, the present invention is directed to liquid crystal display module that substantially obviates one or more of the problems due to limitations and disadvantages of the related art.

Accordingly, it is an advantage of the present invention to provide a liquid crystal display module that prevents noise.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In order to achieve these and other advantages of the invention, a liquid crystal display module according to an embodiment of the present invention includes a support main; and a light guide plate inserted into an inner side of the support main which uniformly distributes light applied from a light source and applies the light to a liquid crystal display panel, wherein the light guide plate is set such that a first side of the light guide plate to which a light is incident has a width different from a second side of the light guide plate opposed to the first side.

In the liquid crystal display module, a width of the first side is larger than a width of the second side.

Herein, the light guide plate is formed in a trapezoidal shape which has a gradually narrower width as the light guide plate extends from the first side to the second side.

The light guide plate has the same width from the first side for a distance and has a gradually narrower width as the light guide plate goes to the second side after the distance.

Herein, the light guide plate has the same width from the first side for ¼ of a length of the light guide plate.

Alternatively, the light guide plate is formed such that the light guide plate keeps the same width as the first side for a distance from the first side and has a stepped portion having the same width as the second side after the distance.

Herein, the light guide plate has the same width from the first side for ¼ of a length of the light guide plate.

The support main is formed in a rectangular shape.

A liquid crystal display module according to an alternative embodiment of the present invention includes a support main; and a light guide plate inserted into an inner side of the support main, which uniformly distributes light applied from a light source and applies the light to a liquid crystal display panel, wherein the support main is set such that a first side of the support main provided with a light source which is incident thereto has a width different from a second side of the support main opposed to the first side.

In the liquid crystal display module, a width of the first side is smaller than a width of the second side.

Herein, the support main is formed in a trapezoidal shape, which has a gradually larger width as the support main extends from the first side to the second side.

The support main has the same width from the first side for a distance and has a gradually larger width as the support main goes to the second side after the distance.

Herein, the support main has the same width from the first side for ¼ of a length of the support main.

Alternatively, the support main is formed such that the support main has the same width as the first side for a distance from the first side and the support main has a stepped portion having the same width as the second side after the distance.

Herein, the first side width of the support main remains constant for ¼ of a length of the support main.

The support main is formed in a rectangular shape.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a section view showing a structure of a conventional liquid crystal display module;

FIG. 2A and FIG. 2B schematically illustrate a light guide plate and a support main shown in FIG. 1, respectively;

FIG. 3 illustrates engagement of a light guide plate and a support main shown in FIG. 2A and FIG. 2B;

FIG. 4 schematically illustrates a light guide plate according to an embodiment of the present invention;

FIG. 5 shows a light guide plate shown in FIG. 4 inserted into a support main;

FIG. 6A and FIG. 6B schematically illustrate a light guide plate according to another embodiment of the present invention;

FIG. 7 schematically illustrates a support main according to an embodiment of the present invention;

FIG. 8 shows a light guide plate inserted into a support main shown in FIG. 7; and

FIG. 9A and FIG. 9B schematically illustrate a support main according to another embodiment of the present invention.

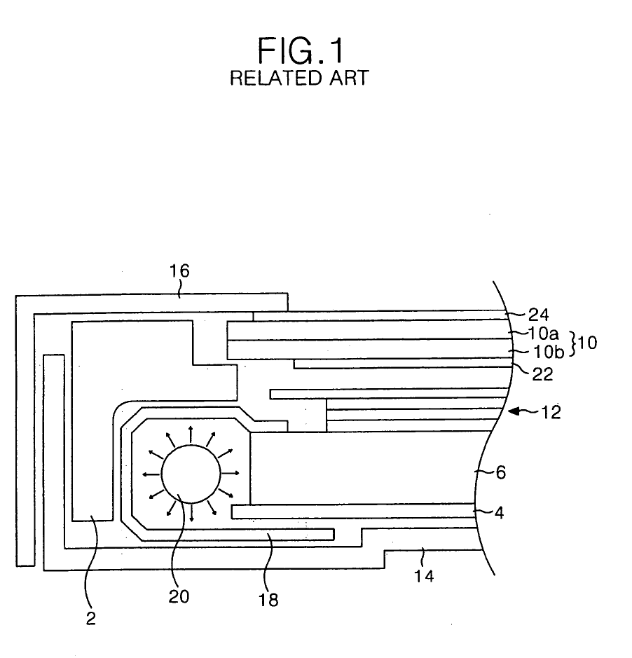

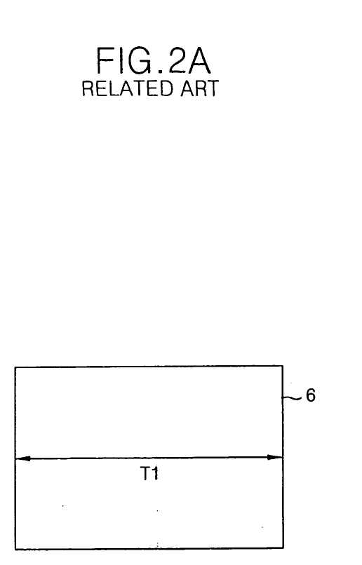

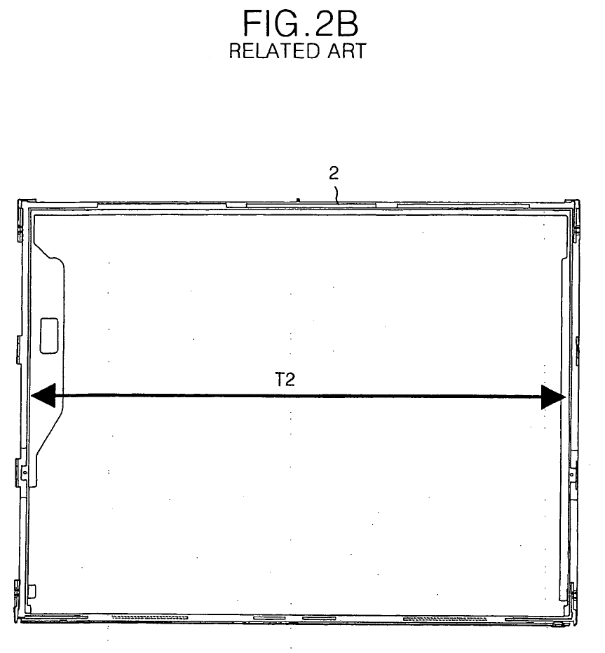

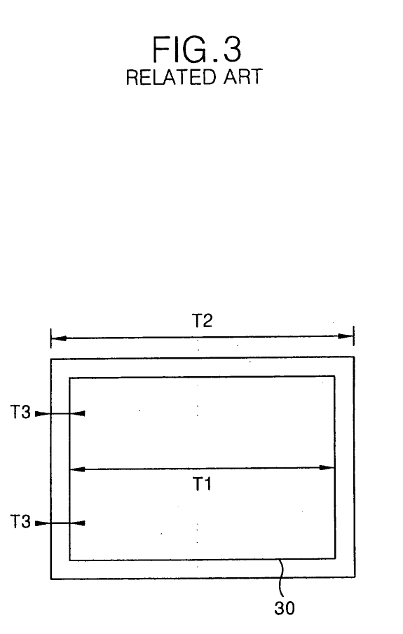

### DETAILED DESCRIPTION OF THE ILLUSTRATED EMBODIMENTS

Reference will now be made in detail to various embodiments of the present invention, examples of which are illustrated in the accompanying drawings.

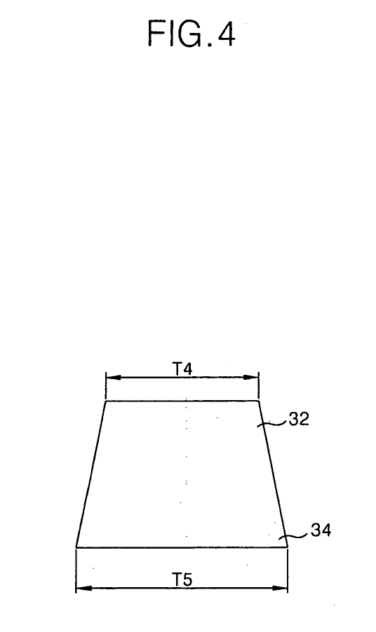

FIG. 4 shows a light guide plate according to an embodiment of the present invention.

Referring to FIG. 4, a light guide plate 32 is formed in a trapezoidal shape. In this embodiment, the light guide plate 32 has a light input part 34 defined at a large width and an opposite side of the light guide part 34 defined at a small width. The light input part 34 has a first width T5 while the opposite side of the light input part 34 thereof has a second width T4 narrower than the first width T5. Herein, the light guide plate 32 has a trapezoidal shape, which gradually narrows as the light guide plate extends from the first width T5 to the second width T4.

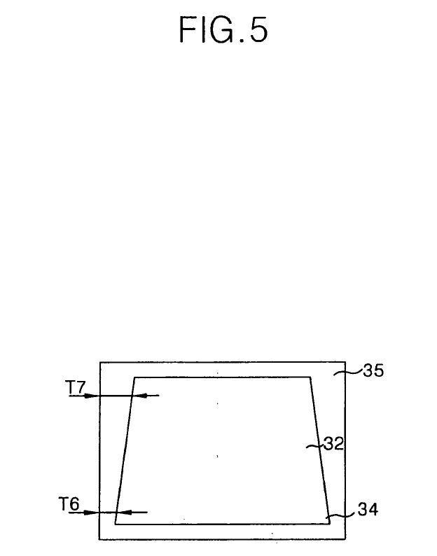

Making reference to FIG. 5, a support main 35 is formed in a rectangular shape. When the light guide plate 32 is inserted into an inner side of the support main 35, the light guide plate 32 and the support main 35 are spaced with respect to each other at a third width T6 at the light input part 34. The light guide plate 32 and the support main 35 are also spaced with respect to each other at a fourth width T7 larger than the third width T6 at the opposite side of the light input part 34.

Accordingly, this embodiment of the present invention minimizes noise generated by friction between the light guide plate 32 and the support main 35. Moreover, this embodiment minimizes noise generation when an external impact at the support main 35 generates twist. More specifically, the light guide plate 32 is spaced, by the large width T7, from the support main 35 at the opposite side of the light input part 34. The spacing between the light guide plate 32 and the support main 35 minimizes contact between the support main 35 and the light guide plate 32 if twisting occurs at the support main 35. Therefore, this configuration minimizes noise caused by friction between the support main 35 and the light guide plate 32.

Furthermore, the light input part 34 has high mechanical strength, which minimizes twisting of the support main 35. In the embodiment shown with reference to FIG. 5, the light guide plate 32 is spaced, by the width T6, which is relatively small, from the support main 35 and the light input part 34.

Thus, noise which may be caused by contact between the support main 35 and the light guide plate 32 is not generated. Accordingly, in this embodiment of the present invention, the side of the light input part 34 of the light guide plate 32 can be widely formed, thereby preventing noise generation with no loss of light input from the light source.

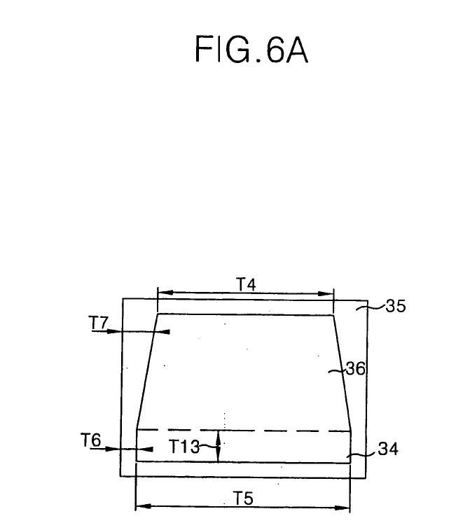

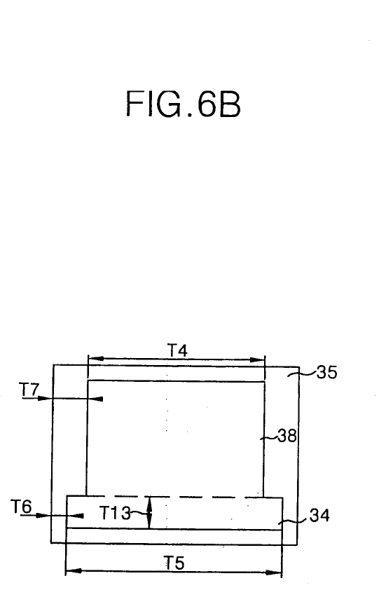

Alternatively, the light guide plate may be formed in various shapes. For example, as shown in FIG. 6A, a light guide plate 36 may be formed such that a side of the light guide plate 36 at the light input part 34 has the first width T5 while the side opposite to the light input part 34 has the second width T4. In this embodiment, the first width T5 is larger than the second width T4.

More specifically, the light guide plate 36 is equally set to the large width T5 the distance T13 from the light input part 34. In this embodiment, the distance T13 is approximately ¼ of a length of the light guide plate 36. Further, a width of the light guide plate 36 gradually narrows from the distance T13. Thus, when the light guide plate 36 is inserted into the support main 35, the light guide plate 36 is spaced by a third width T6 from the support main 35 at the side of the light input part 34. In addition, the light guide plate 36 is spaced by a fourth width T7. In this embodiment, the fourth width T7 is larger than the third width T6 where the fourth width T7 is at a side of the light guide plate 36 opposite from the light input part 34.

Accordingly, this embodiment of the present invention minimizes noise generation caused by friction between the light guide plate 36 and the support main 35. Furthermore, this embodiment of the present invention minimizes noise generation during twisting caused by an external impact.

In accordance with an alternative embodiment, the light guide plate may be formed as shown in FIG. 6B. In this embodiment, a light guide plate 38 is formed such that the side of the light input part 34 has a first width T5 while an opposite side of the light input part 34 has a second width T4. The first width T5 is larger than the second width T4. In addition, a width of the light guide plate 38 extends from the light input part 34 is a distance T13. In this embodiment, a width of the distance T13 approximates the first width T5. Further, a second area of the light guide plate 38 is set to the second width T4, as shown with reference to FIG. 6B.

More specifically, the light guide plate 38 is set to the large width T5 at a distance T13 from the light input part 34. In this embodiment, the distance T13 is approximately ¼ of a length of the light guide plate 38. Further, the light guide plate 38 has a stepped portion extending from the light input part 34 to an end of the light guide plate 38 opposite the light input part 34. To further illustrate, the stepped portion is about ¾ the length of the light guide plate 38. Thus, when the light guide plate 38 is inserted into the support main 35, the light guide plate 38 is spaced, by a third width T6, from the support main 35 at the side of the light input part 34. In this embodiment, the light guide plate 38 is spaced by a fourth width T7 from the support main 35 at the opposite side of the light input part 34. Furthermore, the fourth width T7 is larger than the third width T6 in this embodiment.

Accordingly, this embodiment minimizes noise generation caused by friction between the light guide plate 38 and the support main 35. Furthermore, this embodiment of the present invention minimizes noise generation during twisting caused by an external impact.

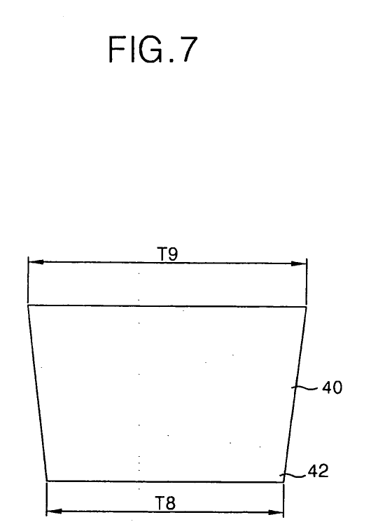

FIG. 7 shows a support main according to an embodiment of the present invention.

Referring to FIG. 7, a support main 40 has a trapezoidal shape. The support main 40 has a light input part 42 (at a side of the support main 40 provided with a light source-defined by a fifth width T8. At a side opposite the light input part 42, the support main 40 has a sixth width T9. Thus, the light input part 42 of the support main 40 has a fifth width T8 while the opposite side of the light input part 42 has a sixth width T9. In this embodiment, the sixth width T9 is larger than the fifth width T8. Additionally, the support main 40 is formed such that support main 40 gradually becomes wider as the support main 40 extends from the fifth width T8 to the sixth width T9.

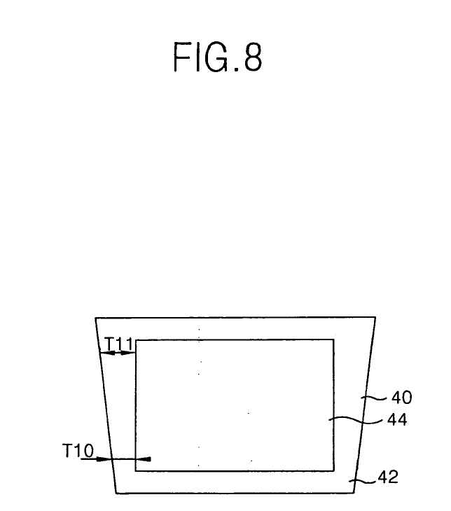

In this embodiment, a light guide plate 44 has a rectangular shape as shown in FIG. 8. When the light guide plate 44 is inserted into an inner side of the support main 40, the light guide plate 44 and the support main 40 are spaced with respect to each other at a seventh width T10 at a side of the light input part 42. Likewise, the support main 40 and the light guide plate 44 are spaced at an eighth width T11 with respect to each other. In this embodiment, the seventh width T10 is at one side of the light input part 42 and the eighth width T11 is at opposite side of the light input part 42 having the seventh width T10. In addition, the eighth width T11 is larger than the seventh width T10.

Accordingly, this embodiment of the present invention minimizes noise generation caused by friction between the light guide plate 44 and the support main 40. Furthermore, this embodiment of the present invention minimizes noise generation during twisting caused by an external impact. More specifically, the light guide plate 44 is spaced by the eighth width T11 from the support main 40 at the opposite side of the light input part 42. Thus, contact between the support main 40 and the light guide plate 44 can be minimized if twist occurs at the support main 40. As such, noise caused by friction between the support main 40 and the light guide plate 44 is minimized.

In addition, the light input part 42 has a high mechanical strength, which minimizes twisting of the support main 40. Thus, contact between the support main 40 and the light guide plate 44 does not generate noise even though the light guide plate 44 is spaced by a small width T10 from the support main 40 at the side of the light input part 42.

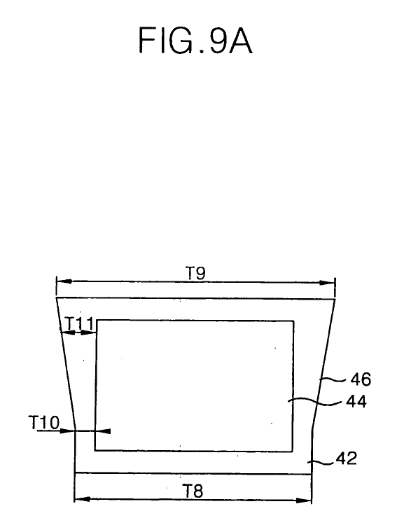

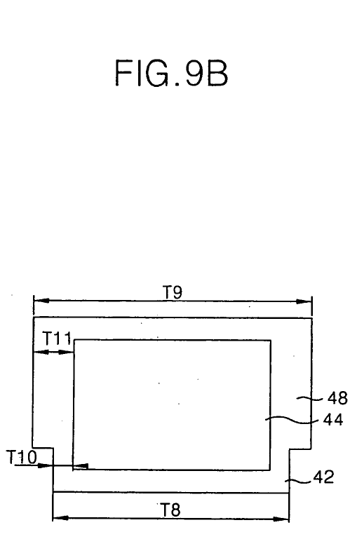

Alternatively, the support main may be formed in various shapes. For instance, as shown in FIG. 9A, a support main 46 may be formed such that a side of the support main 46 at the light input part 42 has a fifth width T8 while the opposite side of the support main 46 has a sixth width T9. The sixth width T9 is larger than the fifth width T8. In this embodiment, a width of the support main 46 extending from the light input part 42 for a distance is equally set to the fifth width T8.

More specifically, the support main 46 includes the fifth width T8. The support main 46 includes the fifth width T8 at an end defined by the light input part 42 and extending there from a distance of approximately ¼ of an overall length of the support main 46. The support main 46 also gradually widens from the fifth width T8 to the sixth width T9 at a side opposite to the light input part 42. Thus, when the light guide plate 44 has been inserted into the support main 46, the light guide plate 44 is spaced by a seventh width T10 from the support main 46 at the side of the light input part 42. Additionally, the light guide plate 44 is spaced by an eighth width T11 from the support main 46 at the side of the light guide plate opposite the input part 42. In this embodiment, the eighth width T11 is larger than the seventh width T10.

Accordingly, this embodiment minimizes noise generation caused by friction between the light guide plate 44 and the support main 46. Furthermore, this embodiment of the present invention minimizes noise generation during twisting caused by an external impact.

Alternatively, the support main may be formed as shown in FIG. 9B. As shown in FIG. 9B, a support main 48 is formed such that the side of the light input part 42 thereof has a fifth width T8. Moreover, the opposite side of the support main 48 has a sixth width T9 larger than the fifth width T8. In this embodiment, a width of the support main 48 extending a distance from the light input part 42 has the fifth width T8 while another width of the support main 48 opposite the light input part 42 has the sixth width T9.

More specifically, the support main 48 includes the fifth width T8. The support main 48 includes the fifth width T8 at an end of the support main 48 defined by the light input part 42 and extending there for a distance of approximately ¼ of a length of the support main 46. Further, the support main 48 has a stepped portion having a large sixth width T9. The stepped portion extends approximately ¾ of the overall length of the support main 46 from the portion of the support main 48 having the fifth width T8. Thus, when the light guide plate 44 has been inserted into the support main 48, the light guide plate 44 is spaced by a seventh width T10 from the support main 48 at the side of the light input part 42. In addition, the light guide plate 44 is spaced by an eighth width T11 from the support main 48 at the opposite side of the light input part 42. The eighth width T11 is larger than the seventh width T10.

Accordingly, this embodiment minimizes noise generation caused by friction between the light guide plate 44 and the support main 48. Furthermore, this embodiment of the present invention minimizes noise generation during twisting caused by an external impact.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display module, comprising:
a support main; and
a light guide plate, the light guide plate being inserted into an inner side of the support main, for uniformly distributing a light applied from a light source and applying the light to a liquid crystal display panel,
the light guide plate having a first side to which the light is incident, the first side having a width different from a width of the second side of the light guide plate, the second side being opposed to the first side.

2. The liquid crystal display module according to claim 1, wherein the width of the first side is larger than the width of the second side.

3. The liquid crystal display module according to claim 2, wherein the light guide plate is formed in a trapezoidal shape having a gradually narrower width from the first side to the second side.

4. The liquid crystal display module according to claim 2, wherein the first side width of the light guide plate remains constant a distance where the light guide plate gradually narrows as the light guide plate extends to the second side after the distance.

5. The liquid crystal display module according to claim 4, wherein the first side width of the light guide plate remains constant for ¼ of a length of the light guide plate.

6. The liquid crystal display module according to claim 2, wherein the light guide plate is formed such that the first side width of the light guide plate remains constant a distance from the first side and has a stepped portion, the stepped portion having the second side width which remains constant after the distance.

7. The liquid crystal display module according to claim 6, wherein the first side width of the light guide plate remains constant for ¼ of a length of the light guide plate.

8. The liquid crystal display module according to claim 1, wherein the support main is formed in a rectangular shape.

9. The liquid crystal display module according to claim 4, wherein the distance is ¼ of a length of the light guide plate.

10. The liquid crystal display module according to claim 6, wherein the distance is ¼ of a length of the light guide plate.

11. A liquid crystal display module, comprising:
a support main; and
a light guide plate, the light guide plate being inserted into an inner side of the support main, for uniformly distributing a light applied from a light source and applying the light to a liquid crystal display panel,
the support main having a first side provided with a light source which is incident thereto, the first side having a width different from a width of a second side of the support main, the second side being opposed to the first side.

12. The liquid crystal display module according to claim 11, wherein the width of the first side is smaller than the width of the second side.

13. The liquid crystal display module according to claim 12, wherein the support main is formed in a trapezoidal shape which has a gradually larger width as the support main extends from the first side to the second side.

14. The liquid crystal display module according to claim 12, wherein the first side width of the support main remains constant a distance and gradually increases in width as the support main extends to the second side after the distance.

15. The liquid crystal display module according to claim 14, wherein the first side width of the support main remains constant for ¼ of a length of the support main.

16. The liquid crystal display module according to claim 12, wherein the support main is formed such that the first side width of the support main remains constant a distance from the first side and has a stepped portion, the stepped portion having the second side width which remains constant after the distance.

17. The liquid crystal display module according to claim 16, wherein the first side width of the support main remains constant for ¼ of a length of the support main.

18. The liquid crystal display module according to claim 11, wherein the light guide plate is formed in a rectangular shape.

19. The liquid crystal display module according to claim 14, wherein the distance is ¼ of a length of the support main.

20. The liquid crystal display module according to claim 16, wherein the distance is ¼ of a length of the support main.
